(19) United States
(12) Patent Application Publication
(10) Pub. No.: US 2025/0376880 A1
(43) Pub. Date: Dec. 11, 2025

(54) ELECTRICAL LOCKING SYSTEM FOR MOTOR VEHICLES HAVING AN EMERGENCY SUPPLY DEVICE

(71) Applicant: Kiekert Aktiengesellschaft, Heiligenhaus (DE)

(72) Inventors: Thorsten BENDEL, Oberhausen (DE); Ömer INAN, Dorsten (DE); Tobias KLOCKE, Mettmann (DE)

(73) Assignee: Kiekert Aktiengesellschaft, Heiligenhaus (DE)

(21) Appl. No.: 18/876,676

(22) PCT Filed: Jun. 1, 2023
(86) PCT No.: PCT/DE2023/100411

§ 371 Date: Dec. 19, 2024

(30) Foreign Application Priority Data
Jun. 24, 2022 (DE) 10 2022 115 827.6

(51) Int. Cl. E05B 81/82; B60Q 1/50; B60R 16/033; E05B 81/04; E05B 81/56; H01M 10/42

(52) U.S. Cl. CPC E05B 81/82; B60Q 1/543; B60R 16/033; E05B 81/04; E05B 81/56; H01M 10/425; H01M 2010/4271; H01M 2220/20

(57) ABSTRACT

The invention relates to an electrical locking system (2) for a motor vehicle (1), comprising a plurality of lock devices (3), in particular electrically operable locks, each having an actuator to which electricity can be applied and which serves at least for unlocking and/or opening a motor vehicle door (9) and/or motor vehicle flap (10), each lock device (3) comprising an emergency supply device (5) having at least one energy store (6) that is designed to provide a supply voltage to the lock device (3) at least for the purposes of unlocking and/or opening the lock device (3) in an emergency operating mode that arises as a result of a predetermined emergency situation, in particular in the event of a failure of a main electrical power source of the motor vehicle (1), the electrical locking system being characterized in that the individual energy stores (6) of the emergency supply devices (5) are electrically interconnected (8).

The invention relates to an electric locking system for a motor vehicle. In particular, the invention relates to an electrical locking system with an emergency supply device with at least one energy store.

Electric door locking systems for motor vehicle doors are known from the prior art, which comprise a plurality of locking devices, in particular locks that can be operated electrically with an actuator that can be acted upon electrically. Such locks that can be operated electrically are, for example, motor vehicle door locks, which open a locking mechanism by means of an electric motor after unlocking.

In a lock that can be operated electrically, the actuator that can be acted upon electrically or, as a rule, an electric motor usually ensures that, for example, the pawl is lifted from its engagement with the catch following an unlocking or opening signal. This means that the unlocking/opening process requires a functioning electrical power supply to the electric motor in the example case. In the case that, for example, a vehicle battery is discharged or otherwise malfunctions, an emergency supply device is often implemented.

This emergency supply device ensures that the lock that can be operated electrically is ready for operation even after the failure or functional impairment of a power source intended for normal opening. An energy store that provides the required voltage is often provided for this purpose.

This energy store can be used to power the actuator during an emergency operation, again at least for unlocking/opening the vehicle door as in normal operation. In normal operation, the actuator is powered by a main power source, such as the motor vehicle battery. If the main power source fails, the emergency supply device ensures that the vehicle door can still be unlocked/opened.

These known emergency supply devices have the disadvantage that individual energy stores of the emergency supply devices can fail.

Based on this situation, it is an object of the present invention to provide an electrical locking system for a motor vehicle in which the reliability of the lock devices is further increased.

The solution to the problem is provided by the features of the independent claims. Advantageous embodiments are specified in the dependent claims.

Accordingly, the invention is achieved by an electrical locking system for a motor vehicle, comprising a plurality of lock devices, in particular electrically operable locks, each with an actuator which can be acted upon electrically, at least for unlocking and/or opening a motor vehicle door and/or motor vehicle flap, wherein each lock device comprises an emergency supply device with at least one energy store, which is arranged to provide a voltage supply to the lock device at least for unlocking and/or opening the lock device in an emergency operation generated by a predetermined emergency, in particular in the event of failure of a main power source of the motor vehicle, characterized in that the individual energy stores of the emergency supply devices are electrically connected to one another.

An essential point of the invention is to provide a decentralized emergency supply device with an energy store for the electrical release and locking/unlocking of doors of a motor vehicle for each lock device, wherein at least the energy stores of the individual emergency supply devices are electrically connected to one another.

In the context of the invention, a motor vehicle door and/or motor vehicle flap can be understood as a door, sliding door, flap or tailgate. This also includes flaps or doors in or on the vehicle as well as hoods, e.g. motor hoods. Flaps should also be understood to mean, for example, a glove compartment or a storage compartment inside the vehicle or storage compartments accessible from the outside.

When the invention refers to a lock device for a motor vehicle, this includes all locks that can be operated electrically and that fix a moving part in a position relative to the motor vehicle. A lock can be located in a side door, a sliding door, a flap or a cover, for example. In particular, wherever moving parts are used by means of a lock device consisting of a locking mechanism and a catch.

In a technically advantageous embodiment of the electrical locking system, the individual energy stores are electrically connected to one another in parallel or electrically connected to one another in series. The individual energy stores of the emergency supply device can be connected to each other in various ways. The parallel connection of two or more energy stores is advantageous, as this allows a higher capacity to be achieved. The serial connection of two or more energy stores makes it possible to achieve a higher voltage.

In a further technical embodiment of the electrical locking system, the lock devices comprise a control apparatus, wherein the emergency supply devices are connected to the control apparatus. This allows the voltage of the energy stores to be monitored by the control apparatus of the lock device and a corresponding signal to be generated if a voltage drop or defect is detected. For example, an error message can be shown on a display, e.g. with a request to change a battery. Monitoring can also be used, for example, to detect a voltage drop caused by external manipulation.

In a technically advantageous embodiment of the electrical locking system, the electrical locking system comprises a power management device, wherein the power management device is set up to detect and/or compensate for deviations in the power supply to the lock devices. The energy management device can be used to compensate for fluctuations in the emergency power supply in each lock device.

In a further technical embodiment of the electrical locking system, at least the energy stores of the emergency supply devices are accessible from outside the motor vehicle. This makes it easy to replace the energy stores.

In a technically advantageous embodiment of the electrical locking system, the energy stores can be inserted into the lock devices at an accessible point on the outside of the motor vehicle. This has the advantage that the energy stores can be easily exchanged and replaced.

In a further technical embodiment of the electrical locking system, the emergency supply devices comprise at least one lighting means as a warning function and/or as a status check for the energy store.

In a technically advantageous embodiment of the electrical locking system, the energy stores are further set up to serve as a long-term energy source for unlocking and/or opening the lock devices. The energy stores can supply the lock devices with the required energy not only in an emergency, e.g. an accident, but also if, for example, the vehicle has been parked for a longer period of time and the main battery is discharged.

In a further technical embodiment of the electrical locking system, the lock devices comprise a signal transmitter for providing an unlocking signal upon actuation, wherein the signal transmitter is set up to be supplied with energy by means of the energy store. In order to maintain the function of the signaling devices, it is advantageous that the signaling transmitters are also supplied with energy from the energy stores.

In a technically advantageous embodiment of the electrical locking system, the control apparatus of the lock devices comprise a wake-up function in order to reduce the energy consumption of the control apparatus.

In a further technical embodiment of the electrical locking system, the energy stores are electrical energy stores and/or electrochemical energy stores. Electrical energy stores include capacitors, for example, which store electrical energy in an electrical field. Electrochemical energy stores include, for example, battery stores or accumulators, which store electrical energy on an electrochemical basis.

The invention is explained in more detail below with reference to the accompanying drawings on the basis of a preferred exemplary embodiment. However, the principle applies that the exemplary embodiments do not limit the invention, but are merely embodiments. The features depicted can be implemented individually or in combination with further features of the description as well as what is claimed-individually or in combination.

In the figures:

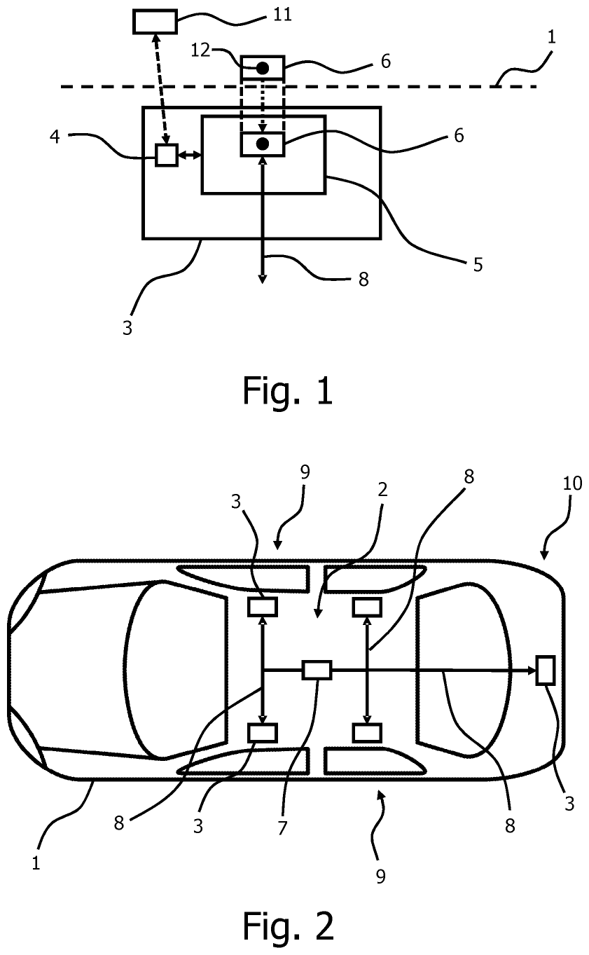

FIG. 1 shows a schematic view of a lock device with an emergency supply device with energy store according to an exemplary embodiment of the invention, FIG. 2 shows a schematic top view of a motor vehicle with an electrical locking system with a plurality of lock devices according to a further exemplary embodiment of the invention.

FIG. 1 shows a schematic view of a lock device 3 with an emergency supply device 5 with an energy store 6 according to an exemplary embodiment of the invention. The lock device 3 shown in FIG. 1 is a component of an electrical locking system 2, for example of a motor vehicle 1. The electrical locking system 2 comprises a plurality of lock devices 3, wherein the lock devices 3 are installed, for example, in vehicle doors 9 and/or vehicle flaps 10. In particular, the term lock device 3 is understood to mean an electrically operated lock. Such an operated lock comprises an actuator which can be acted upon electrically, wherein the actuator is arranged at least for unlocking and/or opening the motor vehicle door 9 and/or the motor vehicle flap 10. Each of the lock devices 3 comprises a control apparatus 4, for example an ECU (“electronic control unit”) for controlling the lock device 3. Furthermore, each lock device 3 comprises an emergency supply device 5 with at least one energy store 6. The emergency supply device 5 is used to supply the actuator with energy by means of the energy store 6 even in the event of a central power supply failure, for example in the event of a motor vehicle battery failure. The individual energy stores 6 of the emergency supply devices 5 are electrically connected 8 to one another. For example, electrical energy stores such as capacitors and/or electrochemical energy stores such as batteries or accumulators can be used as energy stores 6. In one exemplary embodiment, the energy stores 6 for the emergency power supply 5 are directly accessible, for example from the outside, and can be replaced if necessary. For example, the energy stores 6 can be located behind a cover, in the area of the front of the door or on the inside of the door. In one exemplary embodiment, the energy stores 6 can be inserted directly into the lock devices 3 from the outside. This is indicated in FIG. 1 by the vertical dashed lines. It may also be provided that the energy stores 6 can be inserted in a receptacle connected to the control apparatus 4 of the lock device 3, for example in a battery compartment.

In one exemplary embodiment, the energy stores 6 can also be arranged behind a pillar of the vehicle body, for example. The energy supply to the lock device 3 is then provided via a contact between the lock device 3 and a corresponding lock device holder. This has the advantage, for example, that a closed door 9 of the motor vehicle 1 can be reliably detected. This can improve the functional reliability of the electrical locking system 2.

In a further exemplary embodiment, the energy stores 6 can be combined with a lighting means 12, for example an LED. The LED serves as a warning or signal light and can inform the user about the status of the energy store 6, for example.

In a further exemplary embodiment, the control apparatus 4 of the lock devices may comprise a wake-up function in order to reduce the energy consumption of the control apparatus 4. The wake-up function can, for example, be designed as a separate electronic circuit for waking up the main control apparatus 4. This minimizes the quiescent current consumption of the main controller.

In a further exemplary embodiment, the control apparatus 4 of the lock device 3 reacts to a signal transmitter 11 from outside. The signal transmitter 11 is used to transmit a signal to the control apparatus 4, for example that a door 9 is to be opened. Various devices such as Hall sensors, capacitive sensors, various buttons or switches in the door handle or in the lock can be provided as signal transmitters 11. In the emergency described above, the signal transmitters 11 can also be supplied with energy by the control apparatus 4 or the energy store 6 of the emergency supply device 5.

FIG. 2 shows a schematic top view of a motor vehicle 1 with an electrical locking system 2 with a plurality of lock devices 3 according to a further exemplary embodiment of the invention. The lock devices 3 can be electrically operated locks, for example, which are provided for unlocking and/or opening a motor vehicle door 9 and/or motor vehicle flap 10. Each of the lock devices 3 comprises an emergency supply device 5 with an energy store 6. FIG. 2 also shows that the energy stores 6 of the emergency supply devices 5 are electrically connected 8 to one another. In one exemplary embodiment, the energy stores 6 are electrically connected to one another in parallel in order to achieve a higher capacity. In another exemplary embodiment, the energy stores 6 are electrically connected to one another in series, which allows the voltage of the energy stores 6 to be increased.

Furthermore, the electrical locking system 2 shown in FIG. 2 has a power management device 7. The energy stores 6 of the individual emergency supply devices 5 are not only connected to one another, but are also connected to the energy management device 7 in one exemplary embodiment of the invention. The energy management device 7 is set up to detect deviations in the voltages of the energy stores 6 and, for example, to compensate for them by transferring energy from the energy stores 6 not affected by the deviation to the affected energy store 6. This ensures even greater reliability of the individual lock devices 3 even in the event of a failure of the main power supply.

All the features explained in connection with individual embodiments of the invention may be provided in different combinations in the subject matter according to the invention in order to realize their advantageous effect at the same time.

The scope of protection of the present invention is given by the claims and is not limited by the features explained in the description or shown in the figures.

### LIST OF REFERENCE SIGNS

1 motor vehicle
2 electrical locking system
3 lock devices
4 control apparatus of the locking device
5 emergency supply device
6 energy store
7 energy management device
8 electrical connection
9 motor vehicle door
10 motor vehicle flap
11 signal transmitter
12 lighting means

1. An electrical locking system for a motor vehicle, comprising
a plurality of lock devices including locks that are operated electrically, each of the plurality of lock devices comprising an actuator that is acted upon electrically, for unlocking and/or opening a motor vehicle door and/or a motor vehicle flap,
wherein each of the plurality of lock devices comprises an emergency supply device comprising a plurality of energy stores, configured to provide a power supply to a respective one of the plurality of lock devices for unlocking and/or opening the respective one of the plurality of lock devices in an emergency operation generated by a predetermined emergency, including in the event of failure of a main power source of the motor vehicle, and
wherein individual energy stores of the plurality of energy stores of the emergency supply devices are electrically connected to one another.

2. The electrical locking system according to claim 1, wherein the individual energy stores are electrically connected to one another in parallel.

3. The electrical locking system according to claim 1, wherein each of the plurality of the lock devices further comprises a control apparatus, wherein the emergency supply device is connected to the control apparatus.

4. The electrical locking system according to claim 1, wherein the electrical locking system comprises a power management device arranged to detect and/or compensate for deviations in voltages of the plurality of energy stores.

5. The electrical locking system according to claim 1, wherein the plurality of energy stores of the emergency supply devices are accessible from outside the motor vehicle.

6. The electrical locking system according to claim 5, wherein the plurality of energy stores are inserted into the plurality of lock devices at an accessible point on an outside of the motor vehicle.

7. The electrical locking system according to claim 1, wherein the emergency supply devices comprise at least one light as a warning function and/or as a status control for each of the plurality of energy stores.

8. The electrical locking system according to claim 1, wherein the plurality of energy stores are further arranged to serve as a long-time power source for unlocking and/or opening the plurality of lock devices.

9. The electrical locking system according to claim 1, wherein the plurality of lock devices comprise a signal transmitter for providing an unlocking signal upon actuation, wherein the signal transmitter is arranged to be supplied with energy by means of the energy store.

10. The electrical locking system according to claim 1, wherein the control apparatuses of the lock devices comprise a wake-up function to reduce the energy consumption of the control apparatuses.

11. The electrical locking system according to claim 1, wherein the energy stores are electrical energy stores and/or electrochemical energy stores.

12. The electrical locking system according to claim 3, wherein the control apparatus of the locking device is configured to monitor the voltage of the plurality of energy stores and a corresponding signal is generated if a voltage drop or defect is detected.

13. The electrical locking system according to claim 1, wherein the individual energy stores are electrically connected to one another in series.

14. The electrical locking system according to claim 4, wherein the plurality of energy stores of the individual emergency supply devices are connected to the power management device.
